(19) United States
(12) Patent Application Publication
(10) Pub. No.: US 2026/0333528 A1
(43) Pub. Date: Oct. 22, 2026

(54) DRAWER-TYPE MICROWAVE OVEN

(71) Applicants: Guangdong Galanz Enterprises Co., Ltd., Foshan City (CN); Guangdong Galanz Appliances Manufacturing Co., Ltd., Zhongshan City (CN); Guangdong Galanz Microwave Oven and Electrical Appliances Manufacturing Co., Ltd., Foshan City (CN)

(72) Inventors: Liang Wang FENG, Foshan City (CN); Feng LI, Foshan City (CN); Xiao Qiang CHEN, Foshan City (CN)

(21) Appl. No.: 19/653,787

(22) Filed: Apr. 21, 2026

(30) Foreign Application Priority Data
Apr. 21, 2025 (CN) 202520749994.0
Apr. 29, 2025 (CN) 202520838329.9

(51) Int. Cl. H05B 6/64

(52) U.S. Cl. CPC H05B 6/6414

(57) ABSTRACT

A drawer-type microwave oven including a slot on an oven body and a microswitch within the slot; a drawer that includes a door with an elastic hook and an elastic member disposed thereon, one end of the elastic member connected to the elastic hook and the other end of the elastic member connected to the door, the elastic hook includes a locking portion for engagement or disengagement with the slot, which causes the microswitch to conduct or disconnect; a rotation hole, wherein the elastic hook is rotatably connected to the door through the rotation hole; and a connecting hole disposed below the rotation hole. The oven has improved smoothness when opening and closing the door; after the drawer is pulled out, the elastic member pulls the elastic hook to reset, achieving automatic rebound and reducing user operations; and reduces impact noise and wear, and extends service life.

### CROSS-REFERENCE TO RELATED APPLICATIONS

This application claims priority to Chinese Patent Application No. 202520749994.0 filed with the China National Intellectual Property Administration (CNIPA) on Apr. 21, 2025, and Chinese Patent Application No. 202520838329.9 filed with CNIPA on Apr. 29, 2025, the disclosures of both of which are incorporated herein by reference in their entireties.

### FIELD

The present invention relates to the technical field of household appliances, and more specifically, to a drawer-type microwave oven.

### BACKGROUND

With the continuously increasing performance requirements for kitchen appliances in modern households, microwave ovens, as commonly used kitchen heating equipment, have gradually become a focus of user attention.

Existing microwave ovens are inconvenient for placing and retrieving items, and drawer-type microwave ovens have become a focal point of user attention.

The prior art discloses a drawer-type microwave oven, comprising: a cooking cavity, a driving device, a drawer, a door body, a control panel, and a controller; the door body is provided with a hook, the cooking cavity is provided with a slot that engages with the hook, a microswitch is disposed within the slot, the hook can engage or disengage with the slot to cause the microswitch to conduct or disconnect, the control panel is provided with a lock switch, the controller can control the operation of the driving device according to instructions from the control panel, when the lock switch is activated, the controller cannot receive instructions from the control panel, at this time, if the microswitch is disconnected and/or the driving device operates, the controller locks the driving device. Although this significantly improves the child lock function of the drawer-type microwave oven, enabling the child lock mode to not only prevent children from operating the interface but also prevent children from manually pulling out the drawer, thereby better implementing the child lock function, the door hook itself lacks elasticity. First, door opening and closing is not smooth, and when opening the door, contact-type sensing components (such as microswitches) are typically used to determine whether the drawer has reached the maximum door opening stroke, which is prone to causing excessive impact and friction on the sensing components due to excessive movement speed of the drawer assembly, resulting in collision damage to parts; second, the door body cannot automatically rebound to the closed position, requiring users to manually push it closed, increasing operational complexity; third, the rigid collision between the door hook and the oven body causes abnormal sounds between the door body and the machine body, which not only reduces user comfort but also increases equipment wear and shortens service life.

In view of this, the present invention is hereby proposed.

### SUMMARY

The purpose of the present invention is to provide a drawer-type microwave oven to solve the above-mentioned technical problems existing in the door opening/closing process of drawer-type microwave ovens in the prior art.

To achieve the above purpose, the technical solution of the present invention is implemented as follows:
A drawer-type microwave oven, wherein the drawer-type microwave oven comprises:
   an oven body, wherein a slot is provided on the oven body, and a microswitch is disposed within the slot;
   a drawer assembly, wherein the drawer assembly is slidably provided on the oven body, the drawer assembly comprises a door section, an elastic door hook and an elastic member are provided on the door section, one end of the elastic member is connected to the elastic door hook, and the other end of the elastic member is connected to the door section;
   wherein the oven body is provided with a sensing assembly, the drawer assembly is provided with a trigger assembly, and when the drawer assembly moves to the maximum door opening stroke, the trigger assembly is capable of applying magnetic force or projecting light onto the sensing assembly for triggering the sensing assembly;
   wherein the elastic door hook comprises:
      a locking hook portion, wherein engagement or disengagement of the locking hook portion with the slot causes the microswitch to conduct or disconnect;
      a rotation hole, wherein the elastic door hook is rotatably connected to the door section through the rotation hole;
      a connecting hole, wherein the connecting hole is used for mounting the elastic member, and the connecting hole is disposed below the rotation hole.

Further, a first reinforcing protrusion is disposed on the elastic door hook, the first reinforcing protrusion extends upward from the elastic door hook, and the rotation hole is disposed on the first reinforcing protrusion.

Further, a second reinforcing protrusion is disposed on the elastic door hook, the second reinforcing protrusion extends downward from the elastic door hook, and the connecting hole is disposed on the second reinforcing protrusion.

Further, a third reinforcing protrusion is disposed on the first reinforcing protrusion, the third reinforcing protrusion extends in a direction away from the center of the door section, and the rotation hole is disposed through the third reinforcing protrusion.

Further, a fourth reinforcing protrusion is disposed on the first reinforcing protrusion, the fourth reinforcing protrusion extends in a direction toward the center of the door section, and the rotation hole is disposed through the fourth reinforcing protrusion.

Further, the third reinforcing protrusion and the fourth reinforcing protrusion are symmetrically disposed on left and right sides of the first reinforcing protrusion.

Further, a connector is mounted on the oven body, the slot is disposed on the connector, the microswitch is mounted on the connector, an inclined surface portion is disposed on the connector, and the slot is disposed on the rear side of the inclined surface portion.

Further, the elastic member is a spring.

Further, the oven body comprises an inner liner, the drawer assembly is connected to the inner liner in a manner capable of moving in a front-rear direction relative to the inner liner, a sensing assembly is disposed on a front side of the inner liner, and a trigger assembly is disposed on a rear side of the drawer assembly.

Further, the trigger assembly comprises a magnetic structure or a light source component, and the sensing assembly comprises a corresponding reed switch sensor or photocoupler sensor.

Further, the drawer assembly comprises a door section, a support section, and a track assembly, the door section is connected to the support section, the track assembly comprises a fixed track and a movable track, the fixed track is connected to the inner liner, the movable track is connected to the door section and/or the support section, and the movable track is connected to the fixed track and is capable of sliding along the fixed track.

Further, the trigger assembly is connected to a side of the support section remote from the door section, and/or the trigger assembly is connected to a side of the movable track remote from the door section.

Further, the trigger assembly comprises a second mounting bracket and a trigger element, the trigger element is connected to the second mounting bracket in a detachable manner, and the second mounting bracket is connected to a side of the movable track remote from the door section in a detachable manner.

Further, the second mounting bracket is provided with a mounting portion, and the trigger element is snap-fitted to the mounting portion.

Further, the movable track is provided with a groove opening and a first fixing hole, the second mounting bracket is provided with a second fixing hole and is provided with a first arm on a side facing the movable track, the first arm is capable of passing through the groove opening and snap-fitting to the groove opening, and the second fixing hole and the first fixing hole are capable of being assembled by means of a fastener.

Further, an end of the movable track remote from the door section is designated as a tail end, the second mounting bracket is provided with a second arm on a side facing the movable track, and the second arm abuts the tail end.

Further, the second mounting bracket is provided with a positioning post on a side facing the movable track, and the movable track is provided with a positioning hole corresponding to the positioning post.

Further, a front panel is provided on a front side of the inner liner, the sensing assembly is connected to the front panel, and/or the sensing assembly is connected to a side of the inner liner proximate to the front panel.

Further, the sensing assembly comprises a first mounting bracket and a sensing element, the sensing element is connected to the first mounting bracket in a detachable manner, and the first mounting bracket is connected to the front panel in a detachable manner.

As compared with the prior art, the drawer-type microwave oven according to the present invention has the following beneficial effects:

In the drawer-type microwave oven according to the present invention, the elastic door hook cooperates with the elastic member, and the connecting hole is disposed below the rotation hole, serving multiple functions: First, the operational smoothness of opening and closing the door is improved; meanwhile, when the drawer assembly moves to the maximum door opening stroke, the trigger assembly triggers the sensing assembly in a non-contact manner, which can effectively improve sensing accuracy while ensuring that no collision or friction occurs between the sensing assembly and the trigger assembly as the drawer assembly moves, effectively avoiding situations such as excessive impact or friction of sensing components caused by excessively fast movement speed of the drawer assembly; Second, after the drawer assembly is pulled out, the elastic member pulls the elastic door hook to reset, enabling the door section to automatically rebound, reducing user operations; Third, the impact noise between the door section and the oven body is reduced, which not only improves user comfort but also avoids mechanical wear caused by hard collisions, reduces equipment wear, and extends service life; Fourth, the pulling direction of the elastic member forms a reasonable moment with the rotation center of the door hook, reducing lateral deviation and improving locking stability; Fifth, the installation path of the elastic member is shorter, reducing the assembly difficulty of the elastic member.

### BRIEF DESCRIPTION OF THE DRAWINGS

FIG. 1 is a first schematic perspective structural view of a drawer-type microwave oven according to an embodiment of the present invention;

FIG. 2 is a second schematic perspective structural view of a drawer-type microwave oven according to an embodiment of the present invention;

FIG. 3 is a third schematic perspective structural view of a drawer-type microwave oven according to an embodiment of the present invention (left side view);

FIG. 4 is an enlarged schematic perspective structural view of portion A in FIG. 3;

FIG. 5 is a first schematic perspective structural view of an elastic door hook of a drawer-type microwave oven according to an embodiment of the present invention;

FIG. 6 is a second schematic perspective structural view of an elastic door hook of a drawer-type microwave oven according to an embodiment of the present invention;

FIG. 7 is a schematic perspective structural view of a drawer assembly of a drawer-type microwave oven according to an embodiment of the present invention;

FIG. 8 is a schematic perspective structural view of a connector of a drawer-type microwave oven according to an embodiment of the present invention;

FIG. 9 is a fourth schematic perspective structural view of a drawer-type microwave oven according to an embodiment of the present invention;

FIG. 10 is a schematic perspective structural view of an inner liner of a drawer-type microwave oven according to an embodiment of the present invention;

FIG. 11 is a schematic structural view of a drawer-type microwave oven according to an embodiment of the present invention in a closed state of the drawer assembly (with partial oven body structure omitted, right side view);

FIG. 12 is a schematic structural view of a drawer-type microwave oven according to an embodiment of the present invention with the drawer assembly near the maximum door opening stroke (with partial oven body structure omitted);

FIG. 13 is a partial enlarged view of portion B in FIG. 12 according to the embodiment of the present invention;

FIG. 14 is an exploded structural view of the sensing assembly and trigger assembly of a drawer-type microwave oven according to an embodiment of the present invention near the maximum door opening stroke (with partial length of the track assembly omitted);

FIG. 15 is a schematic structural view of the second mounting bracket according to an embodiment of the present invention.

### DESCRIPTION OF REFERENCE SIGNS

100, drawer-type microwave oven; 1, oven body; 12, inner liner; 121, top wall; 122, front panel; 2, drawer assembly; 21, door section; 23, support section; 3, heating chamber; 4, microwave heating assembly; 5, convection assembly; 61, elastic door hook; 611, locking hook portion; 612, rotation hole; 613, connecting hole; 614, first reinforcing protrusion; 615, second reinforcing protrusion; 616, third reinforcing protrusion; 617, fourth reinforcing protrusion; 62, elastic member; 70, connector; 71, slot; 72, microswitch; 73, inclined surface portion; 8, track assembly; 81, fixed track; 82, movable track; 820, tail end; 821, groove opening; 822, positioning hole; 823, first fixing hole; 83, connecting track; 9, sensing assembly; 91, first mounting bracket; 92, sensing element; 10, trigger assembly; 101, second mounting bracket; 1011, mounting portion; 1012, first arm; 1013, second arm; 1014, positioning post; 1015, second fixing hole; 102, trigger element.

### DETAILED DESCRIPTION OF THE PREFERRED EMBODIMENTS

The inventive concepts of the present disclosure will be described below using terminology commonly used by those skilled in the art to convey the substance of their work to others skilled in the art. However, these inventive concepts may be embodied in many different forms and therefore should not be construed as limited to the embodiments described herein.

It should be noted that the embodiments of the present invention and the features in the embodiments may be combined with each other without conflict.

The present invention will be described in detail below with reference to the accompanying drawings in conjunction with embodiments.

### Embodiment 1

In the prior art, the door hook itself lacks elasticity, which causes the following problems: first, the opening and closing of the door is not smooth; second, the door body cannot automatically rebound to the closed position, requiring the user to manually push it tight, thereby increasing operational complexity; third, the rigid collision between the door hook and the oven body causes abnormal noise between the door body and the machine body, which not only reduces user comfort but also increases equipment wear and shortens service life.

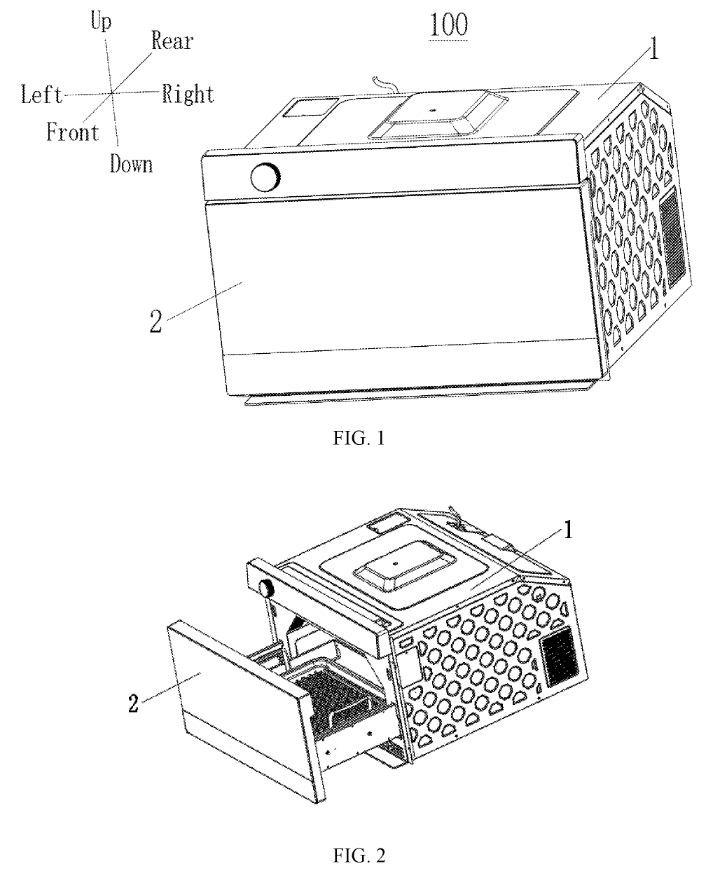

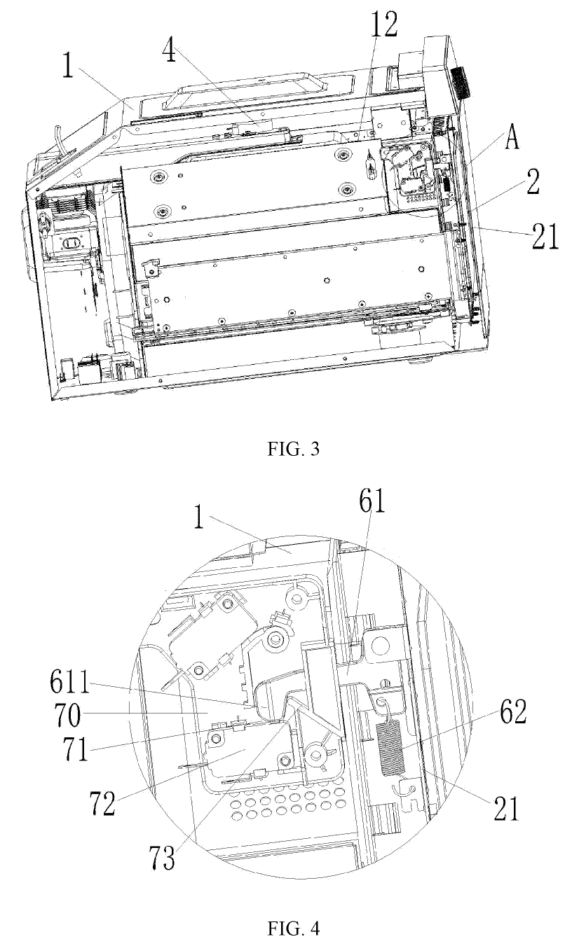

In order to solve the above technical problems, as shown in FIGS. 1-10, the present embodiment proposes a drawer-type microwave oven 100.

The drawer-type microwave oven 100 comprises:
an oven body 1, wherein a slot 71 is provided on the oven body 1, and a microswitch 72 is provided within the slot 71;
a drawer assembly 2, wherein the drawer assembly 2 is slidably provided on the oven body 1, the drawer assembly 2 comprises a door section 21, an elastic door hook 61 and an elastic member 62 are provided on the door section 21, one end of the elastic member 62 is connected to the elastic door hook 61, and the other end of the elastic member 62 is connected to the door section 21, forming a lever structure;

The elastic door hook 61 comprises:
a locking hook portion 611, wherein engagement or disengagement of the locking hook portion 611 with the slot 71 causes the microswitch 72 to conduct or disconnect;
a rotation hole 612, serving as a rotation pivot, wherein the rotation hole 612 enables the elastic door hook 61 to rotate about the door section 21, and the elastic door hook 61 is rotatably connected to the door section 21 through the rotation hole 612;
a connecting hole 613, wherein the connecting hole 613 is used for mounting the elastic member 62, and the connecting hole 613 is disposed below the rotation hole 612.

The cooperation between the elastic door hook 61 and the elastic member 62 serves multiple functions: first, improving the operational smoothness of opening and closing the door; second, after the drawer assembly 2 is pulled out, the elastic member 62 pulls the elastic door hook 61 to reset, enabling the door section 21 to automatically rebound, thereby reducing user operations; third, reducing the impact noise between the door section 21 and the oven body 1, which not only improves user comfort but also avoids mechanical wear caused by hard collisions, reduces equipment wear, and extends service life.

The arrangement of the connecting hole 613 below the rotation hole 612 serves multiple functions: first, the pulling direction of the elastic member 62 forms a reasonable moment with the rotation center of the elastic door hook 61 (i.e., the rotation hole 612), reducing lateral offset and improving locking stability; second, the pulling direction of the elastic member 62 is consistent with the push-pull direction of the drawer assembly 2, reducing operational resistance and further improving operational smoothness; third, the installation path of the elastic member 62 is shorter, reducing the assembly difficulty of the elastic member 62.

In summary, the present embodiment proposes a drawer-type microwave oven 100, wherein the elastic door hook 61 and the elastic member 62 cooperate with each other, and the connecting hole 613 is disposed below the rotation hole 612, serving multiple functions: first, improving the operational smoothness of opening and closing the door; second, after the drawer assembly 2 is pulled out, the elastic member 62 pulls the elastic door hook 61 to reset, enabling the door section 21 to automatically rebound, thereby reducing user operations; third, reducing the impact noise between the door section 21 and the oven body 1, which not only improves user comfort but also avoids mechanical wear caused by hard collisions, reduces equipment wear, and extends service life; fourth, the pulling direction of the elastic member 62 forms a reasonable moment with the rotation center of the elastic door hook 61 (i.e., the rotation hole 612), reducing lateral offset and improving locking stability; fifth, the installation path of the elastic member 62 is shorter, reducing the assembly difficulty of the elastic member 62.

Specifically, the locking hook portion 611 is disposed on a side away from the door section 21, and the rotation hole 612 and connecting hole 613 are disposed on a side close to the door section 21.

Specifically, as shown in FIG. 7, the drawer assembly 2 further comprises a placement section and a support section 23, wherein the placement section is capable of placing an object to be heated thereon; and the support section 23 is capable of supporting the placement section.

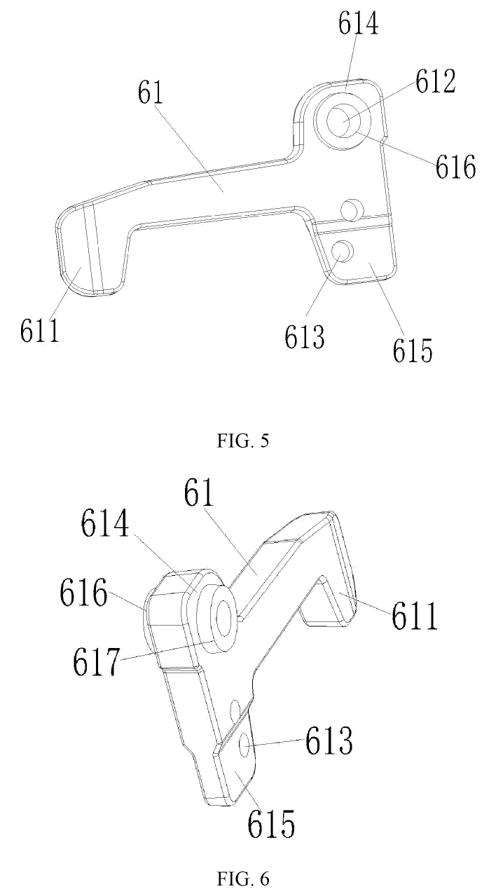

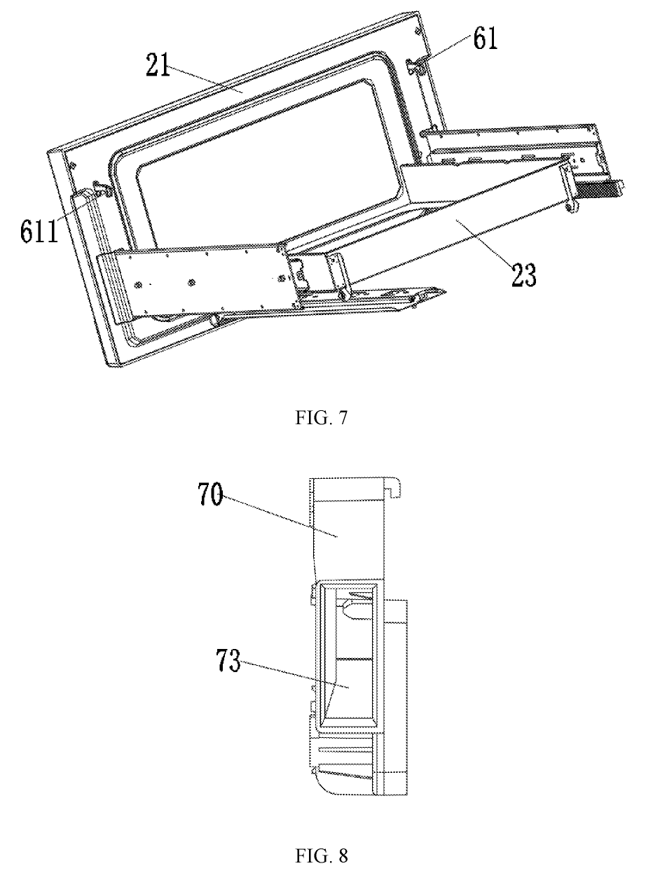

As a preferred example of the present application, as shown in FIG. 5 and FIG. 6, a first reinforcing protrusion 614 is disposed on the elastic door hook 61, the first reinforcing protrusion 614 extends upwardly from the elastic door hook 61, and the rotation hole 612 is disposed on the first reinforcing protrusion 614. This arrangement improves the structural strength at the rotation hole 612, thereby improving the rotational stability of the elastic door hook 61.

As a preferred example of the present application, as shown in FIG. 5 and FIG. 6, a second reinforcing protrusion 615 is disposed on the elastic door hook 61, the second reinforcing protrusion 615 extends downwardly from the elastic door hook 61, and the connecting hole 613 is disposed on the second reinforcing protrusion 615. This arrangement improves the structural strength at the connecting hole 613, thereby improving the connection stability between the elastic door hook 61 and the elastic member 62.

As a preferred example of the present application, as shown in FIG. 5, a third reinforcing protrusion 616 is disposed on the first reinforcing protrusion 614, the third reinforcing protrusion 616 extends in a direction away from the center of the door section 21, and the rotation hole 612 is disposed through the third reinforcing protrusion 616. This arrangement further improves the structural strength at the rotation hole 612, thereby further improving the rotational stability of the elastic door hook 61.

As a preferred example of the present application, as shown in FIG. 6, a fourth reinforcing protrusion 617 is disposed on the first reinforcing protrusion 614, the fourth reinforcing protrusion 617 extends in a direction toward the center of the door section 21, and the rotation hole 612 is disposed through the fourth reinforcing protrusion 617. This arrangement further improves the structural strength at the rotation hole 612, thereby further improving the rotational stability of the elastic door hook 61.

As a preferred example of the present application, as shown in FIG. 6, the third reinforcing protrusion 616 and the fourth reinforcing protrusion 617 are symmetrically disposed on the left and right sides of the first reinforcing protrusion 614. This arrangement improves the balance of structural strength at the rotation hole 612, thereby further improving the rotational balance and stability of the elastic door hook 61.

As a preferred example of the present application, as shown in FIG. 4, a connector 70 is mounted on the oven body 1, the slot 71 is disposed on the connector 70, and the microswitch 72 is mounted on the connector 70. As shown in FIG. 4 and FIG. 8, an inclined surface portion 73 is disposed on the connector 70, and as shown in FIG. 4, the slot 71 is disposed on the rear side of the inclined surface portion 73.

Integrating the slot 71, the microswitch 72, and the inclined surface portion 73 on a single connector 70 avoids the scattered installation of multiple components on the oven body 1, reduces assembly complexity, and improves installation efficiency. The inclined surface portion 73 serves as a guiding structure for the elastic door hook 61 to insert into the slot 71, optimizing operational smoothness. The inclined surface portion 73 prevents hard collision between the elastic door hook 61 and the edge of the slot 71, reducing noise while extending component lifespan.

Specifically, the elastic member 62 is not specifically limited.

As a preferred example of the present application, as shown in FIG. 4, the elastic member 62 is a spring. The spring has a fast response speed and smooth operation; the elastic potential energy of the spring is released rapidly, allowing the elastic door hook 61 to reset instantaneously, thereby improving the smoothness of pushing and pulling the drawer assembly 2; the spring can absorb the impact force between the elastic door hook 61 and the slot 71, reducing abnormal noise and wear; furthermore, the spring has a simple structure and low cost.

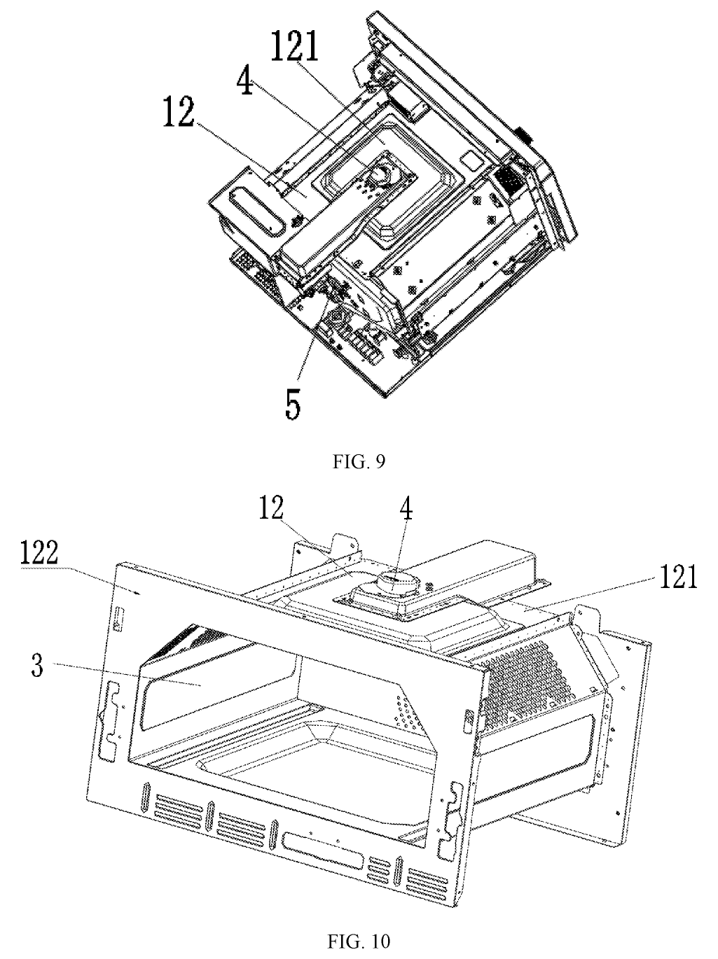

As a preferred example of the present application, as shown in FIG. 9, the oven body 1 includes an inner liner 12. As shown in FIG. 10, a heating chamber 3 is formed within the inner liner 12. A microwave heating assembly 4 is provided on the oven body 1, and the microwave heating assembly 4 is used to deliver microwaves to the heating chamber 3. As shown in FIG. 9 and FIG. 10, the microwave heating assembly 4 is disposed on the top wall 121 of the inner liner 12.

This design has numerous advantages: first, it enables microwaves to cover the food in the heating chamber 3 relatively uniformly, improving the heating uniformity of the food; second, the structural layout is reasonable, as disposing the microwave heating assembly 4 on the top wall 121 does not occupy the side wall or rear wall space of the inner liner 12, making the internal space of the heating chamber 3 more regular, which facilitates food placement and the cooking process; third, the top wall 121 position is relatively open, facilitating the installation and removal of the microwave heating assembly 4.

As a preferred example of the present application, as shown in FIG. 9, a convection assembly 5 is provided on the oven body 1, and the convection assembly 5 is used to form circulating air within the heating chamber 3.

In the present application, the convection assembly 5 cooperates with the microwave heating assembly 4 to achieve a dual heating method combining microwave heating and convection heating. Microwave heating can rapidly penetrate the food, causing the interior of the food to heat up quickly, while convection heating can form a crispy, browned outer crust on the food surface while ensuring uniform heating of the food interior. This synergistic effect greatly improves cooking efficiency and cooking quality.

The present embodiment proposes a drawer-type microwave oven 100, wherein the elastic door hook 61 cooperates with the elastic member 62, and the connecting hole 613 is disposed below the rotation hole 612, serving multiple functions: first, improving the operational smoothness of opening and closing the door; second, after the drawer assembly 2 is pulled out, the elastic member 62 pulls the elastic door hook 61 to reset, enabling the door section 21 to achieve automatic rebound, reducing user operations; third, reducing the impact sound between the door section 21 and the oven body 1, which not only improves user comfort but also avoids mechanical wear caused by hard collisions, reducing equipment wear and extending service life; fourth, the pulling direction of the elastic member 62 forms a reasonable moment with the rotation center (i.e., rotation hole 612) of the elastic door hook 61, reducing lateral deviation and improving locking stability; fifth, the installation path of the elastic member 62 is shorter, reducing the assembly difficulty of the elastic member 62.

### Embodiment 2

Embodiment 1 relates to structures associated with door closing of the drawer-type microwave oven 100. For the door opening action of the drawer-type microwave oven 100, the prior art typically achieves automatic opening of the drawer assembly 2 through a motor capable of driving the drawer assembly 2 to be pulled out. However, during use of existing drawer-type microwave ovens, due to defects in improper arrangement of structural components for controlling the maximum door opening stroke, there is a certain lag in the maximum door opening stroke, causing the motor to continue operating after the drawer assembly 2 has reached the maximum door opening stroke, thereby increasing the risk of damage to the motor or other door opening-related components; additionally, during door opening, contact-type sensing components (such as microswitches) are typically used to determine whether the drawer has reached the maximum door opening stroke, which is prone to excessive impact and friction of the sensing components due to excessively fast movement speed of the drawer assembly, resulting in collision damage to components.

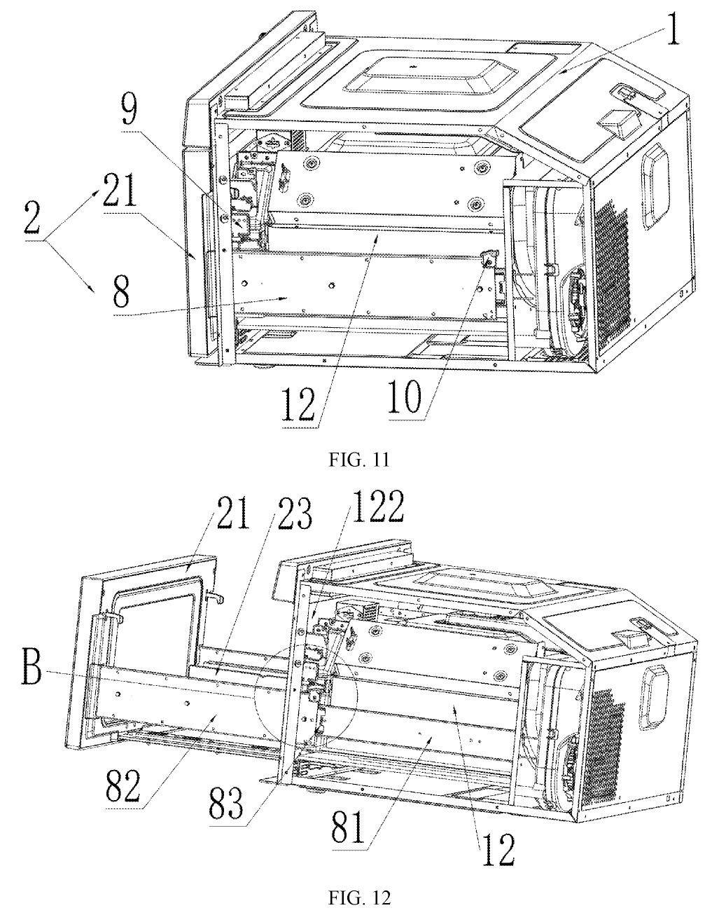

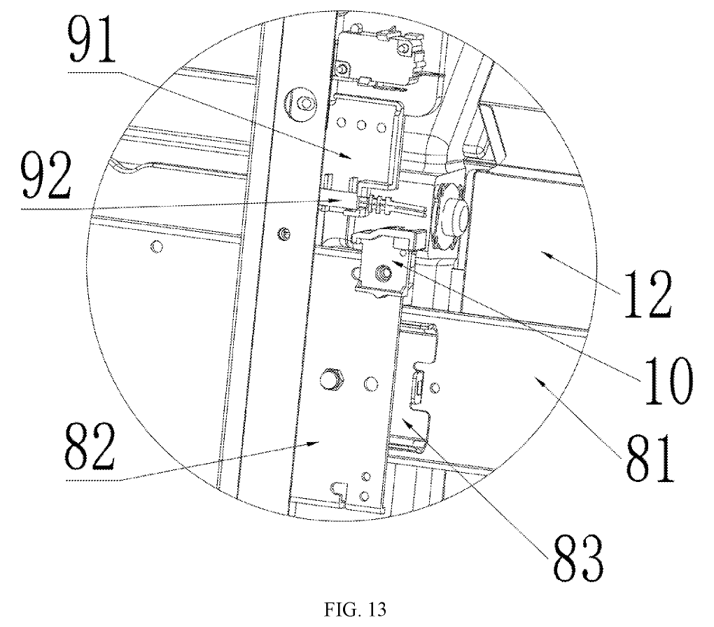

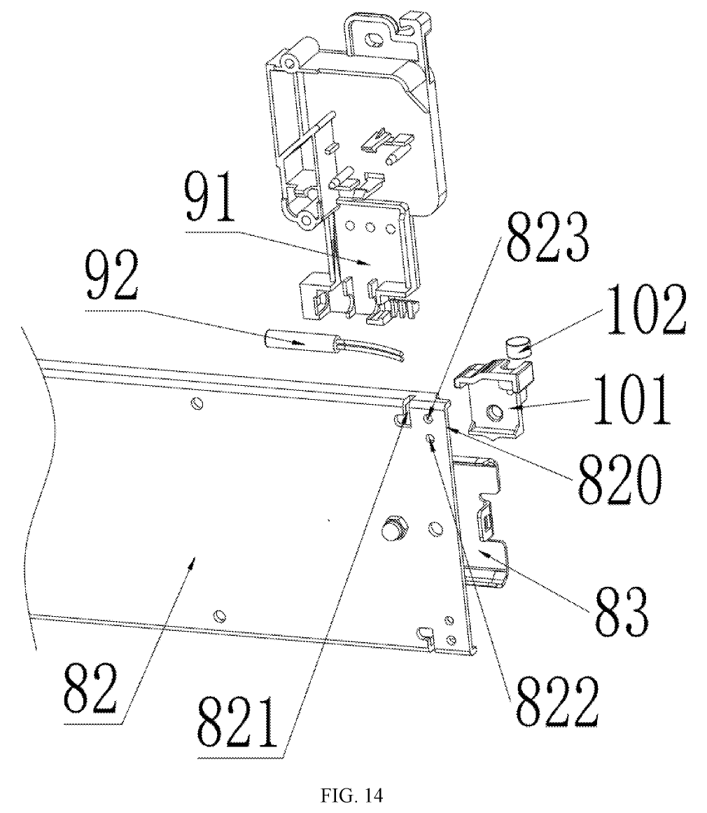

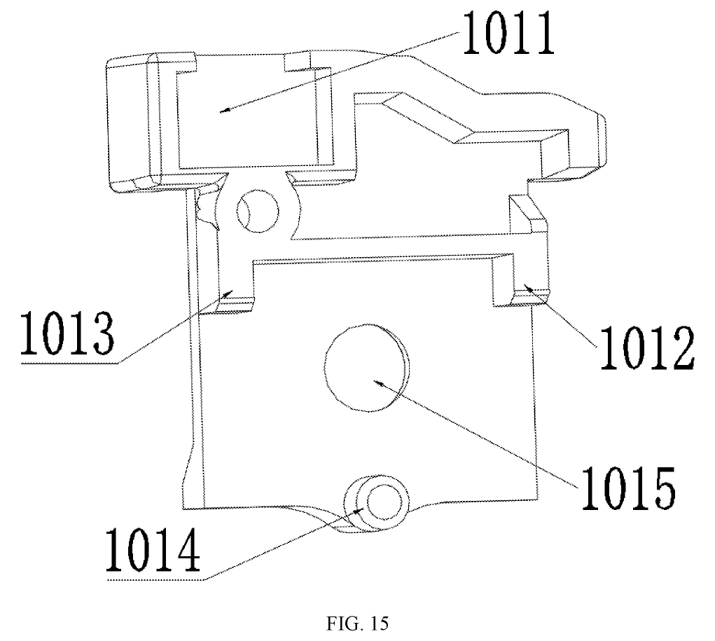

In order to solve the problem in the prior art of improper arrangement of structural components for controlling the maximum door opening stroke of the drawer-type microwave oven 100, the present embodiment proposes a drawer-type microwave oven 100. As shown in FIGS. 10-15, the drawer-type microwave oven 100 comprises an inner liner 12 and a drawer assembly 2. The drawer assembly 2 is connected to the inner liner 12 in a manner capable of moving relative to the inner liner 12 in the front-rear direction. A sensing assembly 9 is provided on the front side of the inner liner 12, and a trigger assembly 10 is provided on the rear side of the drawer assembly 2. When the drawer assembly 2 moves to the maximum door opening stroke position, the trigger assembly 10 is capable of applying magnetic force to or projecting light onto the sensing assembly 9 for triggering the sensing assembly 9.

It should be noted that the maximum door opening stroke refers to the position corresponding to the maximum distance that the drawer assembly 2 moves forward in the cooking appliance.

Accordingly, the present application, while maintaining the structure of a conventional drawer-type microwave oven 100, only requires additionally providing the sensing assembly 9 and trigger assembly 10 at corresponding positions. When the drawer assembly 2 moves to the maximum door opening stroke position, the sensing assembly 9 can be triggered by the trigger assembly 10, thereby timely stopping the movement of the drawer assembly 2, preventing the door opening motor from continuing to operate, and eliminating damage to the motor or related components caused by excessive door opening.

Meanwhile, the trigger assembly 10 of the present application triggers the sensing assembly 9 in a non-contact manner, which can effectively improve sensing accuracy. At the same time, as the drawer assembly moves, no collision or friction occurs between the sensing assembly 9 and the trigger assembly 10, which can effectively avoid excessive impact and friction of the sensing components caused by excessively fast movement speed of the drawer assembly, thereby helping to ensure the structural integrity and operational safety of both the trigger assembly 10 and the sensing assembly 9, and contributing to extending their service life.

Preferably, the trigger assembly 10 has a magnetic structure or a light source component, and the sensing assembly 9 has a corresponding reed switch sensor or photocoupler sensor.

The drawer assembly 2 comprises a door section 21, a support section 23, and a track assembly 8. The door section 21 is connected to the support section 23. The track assembly 8 comprises a fixed track 81 and a movable track 82. The fixed track 81 is connected to the inner liner 12, and the movable track 82 is connected to the door section 21 and/or the support section 23. The movable track 82 is connected to the fixed track 81 and is capable of sliding along the fixed track 81. This enables the drawer assembly 2 to move relative to the inner liner 12, achieving extension and retraction of the drawer assembly. Wherein, the fixed track 81 has a slide groove structure, and the movable track 82 is capable of sliding within the slide groove. The track assembly 8 further comprises a connecting track 83. The connecting track 83 is disposed between the fixed track 81 and the movable track 82. Wherein, the width of the connecting track 83 does not exceed the slide groove width of the fixed track 81, such that the connecting track 83 is positioned within the slide groove. The movable track 82 wraps around the outside of the connecting track 83, and the connecting track 83 drives the movable track 82 to slide.

A front panel 122 is provided on the front side of the inner liner 12, and the sensing assembly 9 is connected to the front panel 122, and/or the sensing assembly 9 is connected to a side of the inner liner 12 adjacent to the front panel 122. Preferably, the sensing assembly 9 comprises a first mounting bracket 91 and a sensing element 92, wherein the sensing element 92 is connected to the first mounting bracket 91 in a detachable manner, and the first mounting bracket 91 is connected to the front panel 122 in a detachable manner, thereby facilitating disassembly and maintenance of the sensing assembly 9 while ensuring stable installation of the sensing assembly 9. Specifically, the first mounting bracket 91 is provided with a snap-fit groove, and the sensing element 92 is capable of snap-fitting with the snap-fit groove; the first mounting bracket 91 is provided with snap claws and screw holes, snap-fits with the front panel 122 through the snap claws and is further secured to the front panel 122 through fasteners. Wherein, the sensing element 92 may be a reed switch sensor or a light sensor.

The trigger assembly 10 is connected to a side of the support section 23 remote from the door section 21, and/or the trigger assembly 10 is connected to a side of the movable track 82 remote from the door section 21. Preferably, the trigger assembly 10 comprises a second mounting bracket 101 and a trigger element 102, wherein the trigger element 102 is connected to the second mounting bracket 101 in a detachable manner, and the second mounting bracket 101 is connected to a side of the movable track 82 remote from the door section 21 in a detachable manner, thereby facilitating disassembly and maintenance of the trigger assembly 10 while ensuring stable installation of the trigger assembly 10. Wherein, the trigger element 102 may be a magnet or a light emitter.

The second mounting bracket 101 is provided with a mounting portion 1011, and the trigger element 102 snap-fits with the mounting portion 1011; the movable track 82 is provided with a groove opening 821 and a first fixing hole 823, the second mounting bracket 101 is provided with a second fixing hole 1015 and is provided with a first arm 1012 on a side facing the movable track 82, wherein the first arm 1012 is capable of penetrating through the groove opening 821 and snap-fitting with the groove opening 821, and the second fixing hole 1015 and the first fixing hole 823 are capable of being assembled through fasteners. This ensures the assembly stability of the entire trigger assembly 10 and also reduces the risk of the trigger assembly 10 becoming loose or detached during movement with the drawer assembly 2.

The end of the movable track 82 remote from the door section 21 is designated as a tail end 820, and the second mounting bracket 101 is provided with a second arm 1013 on a side facing the movable track 82, wherein the second arm 1013 abuts the tail end 820. Thus, on the basis of the first snap-fit relationship formed between the first arm 1012 and the groove opening 821, by further providing the second arm 1013, a snap-fit space is also formed between the first arm 1012 and the second arm 1013, forming a second snap-fit relationship with the movable track 82 at the tail end 820, which helps to further improve the assembly reliability of the entire trigger assembly 10.

On this structural basis, in order to improve the assembly convenience of the second mounting bracket 101 and the movable track 82, the second mounting bracket 101 is provided with a positioning post 1014 on a side facing the movable track 82, and the movable track 82 is provided with a positioning hole 822 corresponding to the positioning post 1014. Thus, when assembling the second mounting bracket 101 with the movable track 82, it is only necessary to first insert the positioning post 1014 into the positioning hole 822 and bring the second arm 1013 into contact with the tail end 820, and then force can be directly applied to the second mounting bracket 101 to cause the first arm 1012 to enter the groove opening 821, thereby easily completing the two snap-fit connections between the second mounting bracket 101 and the movable track 82 in one operation; at the same time, the first fixing hole 823 and the second fixing hole 1015 can also be automatically aligned without secondary adjustment, and without the need for a person to hold the second mounting bracket 101, fasteners can be directly installed toward the first fixing hole 823 and the second fixing hole 1015. Correspondingly, this structure can effectively improve assembly convenience, and the assembly can be completed by only one person.

Furthermore, for the drawer assembly 2 of the present application, one, two, or even multiple track assemblies 8 may be provided. Correspondingly, the sensing assembly 9, the trigger assembly 10, and the related assembly relationships described in the present application may be provided only at any one of the track assemblies 8. Of course, without considering structural complexity, the sensing assembly 9, the trigger assembly 10, and the related assembly relationships described in the present application may also be provided at each of the track assemblies 8.

On the basis of the related structures introduced in the present application, the drawer-type microwave oven 100 further comprises conventional structures such as electrical control components and heat dissipation components. Since these conventional structures may directly refer to the prior art, they will not be described in detail.

The foregoing descriptions are merely preferred embodiments of the present invention and are not intended to limit the present invention. Any modifications, equivalent substitutions, improvements, and the like made within the spirit and principles of the present invention shall be included within the scope of protection of the present invention.

1. A drawer-type microwave oven, comprising:
an oven body, wherein a slot is provided on the oven body, and a microswitch is disposed within the slot; and
a drawer assembly, wherein the drawer assembly is slidably provided on the oven body, the drawer assembly comprises a door section, an elastic door hook and an elastic member are provided on the door section, one end of the elastic member is connected to the elastic door hook, and the other end of the elastic member is connected to the door section;
wherein the oven body is provided with a sensing assembly, the drawer assembly is provided with a trigger assembly, and when the drawer assembly moves to the maximum door opening stroke, the trigger assembly is capable of applying magnetic force or projecting light onto the sensing assembly for triggering the sensing assembly;
wherein the elastic door hook comprises:
a locking hook portion, wherein engagement or disengagement of the locking hook portion with the slot causes the microswitch to conduct or disconnect;
a rotation hole, wherein the elastic door hook is rotatably connected to the door section through the rotation hole; and
a connecting hole, wherein the connecting hole is used for mounting the elastic member, and the connecting hole is disposed below the rotation hole.

2. A drawer-type microwave oven of claim 1, wherein a first reinforcing protrusion is disposed on the elastic door hook, the first reinforcing protrusion extends upward from the elastic door hook, and the rotation hole is disposed on the first reinforcing protrusion.

3. A drawer-type microwave oven of claim 2, wherein a second reinforcing protrusion is disposed on the elastic door hook, the second reinforcing protrusion extends downward from the elastic door hook, and the connecting hole is disposed on the second reinforcing protrusion.

4. A drawer-type microwave oven of claim 3, wherein a third reinforcing protrusion is disposed on the first reinforcing protrusion, the third reinforcing protrusion extends in a direction away from the center of the door section, and the rotation hole is disposed through the third reinforcing protrusion.

5. A drawer-type microwave oven of claim 4, wherein a fourth reinforcing protrusion is disposed on the first reinforcing protrusion, the fourth reinforcing protrusion extends in a direction toward the center of the door section, and the rotation hole is disposed through the fourth reinforcing protrusion.

6. A drawer-type microwave oven of claim 5, wherein the third reinforcing protrusion and the fourth reinforcing protrusion are symmetrically disposed on left and right sides of the first reinforcing protrusion.

7. A drawer-type microwave oven of claim 1, wherein a connector is mounted on the oven body, the slot is disposed on the connector, the microswitch is mounted on the connector, an inclined surface portion is disposed on the connector, and the slot is disposed on the rear side of the inclined surface portion.

8. A drawer-type microwave oven of claim 1, wherein the elastic member is a spring.

9. A drawer-type microwave oven of claim 1, wherein the oven body comprises an inner liner, the drawer assembly is connected to the inner liner in a manner capable of moving in a front-rear direction relative to the inner liner, a sensing assembly is disposed on a front side of the inner liner, and a trigger assembly is disposed on a rear side of the drawer assembly.

10. A drawer-type microwave oven of claim 9, wherein the trigger assembly comprises a magnetic structure or a light source component, and the sensing assembly comprises a corresponding reed switch sensor or photocoupler sensor.

11. A drawer-type microwave oven of claim 9, wherein the drawer assembly comprises a door section, a support section, and a track assembly, the door section is connected to the support section, the track assembly comprises a fixed track and a movable track, the fixed track is connected to the inner liner, the movable track is connected to the door section and/or the support section, and the movable track is connected to the fixed track and is capable of sliding along the fixed track.

12. A drawer-type microwave oven of claim 11, wherein the trigger assembly is connected to a side of the support section remote from the door section, and/or the trigger assembly is connected to a side of the movable track remote from the door section.

13. A drawer-type microwave oven of claim 12, wherein the trigger assembly comprises a second mounting bracket and a trigger element, the trigger element is connected to the second mounting bracket in a detachable manner, and the second mounting bracket is connected to a side of the movable track remote from the door section in a detachable manner.

14. A drawer-type microwave oven of claim 13, wherein the second mounting bracket is provided with a mounting portion, and the trigger element is snap-fitted to the mounting portion.

15. A drawer-type microwave oven of claim 13, wherein the movable track is provided with a groove opening and a first fixing hole, the second mounting bracket is provided with a second fixing hole and is provided with a first arm on a side facing the movable track, the first arm is capable of passing through the groove opening and snap-fitting to the groove opening, and the second fixing hole and the first fixing hole are capable of being assembled by means of a fastener.

16. A drawer-type microwave oven of claim 15, wherein an end of the movable track remote from the door section is designated as a tail end, the second mounting bracket is provided with a second arm on a side facing the movable track, and the second arm abuts the tail end.

17. A drawer-type microwave oven of claim 15, wherein the second mounting bracket is provided with a positioning post on a side facing the movable track, and the movable track is provided with a positioning hole corresponding to the positioning post.

18. A drawer-type microwave oven of claim 9, wherein a front panel is provided on a front side of the inner liner, the sensing assembly is connected to the front panel, and/or the sensing assembly is connected to a side of the inner liner proximate to the front panel.

19. A drawer-type microwave oven of claim 18, wherein the sensing assembly comprises a first mounting bracket and a sensing element, the sensing element is connected to the first mounting bracket in a detachable manner, and the first mounting bracket is connected to the front panel in a detachable manner.
